(19) United States
(12) Patent Application Publication
(10) Pub. No.: US 2025/0162669 A1
(43) Pub. Date: May 22, 2025

(54) Scooter Stand

(71) Applicant: Resilient Accessories LLC, Jacksonville, FL (US)

(72) Inventor: Charles R. Hammerslough, Jacksonville, FL (US)

(73) Assignee: Resilient Accessories LLC, Jacksonville, FL (US)

(21) Appl. No.: 19/032,421

(22) Filed: Jan. 20, 2025

Related U.S. Application Data
(63) Continuation of application No. 18/627,425, filed on Apr. 4, 2024, now Pat. No. 12,202,561.
(60) Provisional application No. 63/457,102, filed on Apr. 4, 2023.

(51) Int. Cl. B62H 3/02

(52) U.S. Cl. CPC B62H 3/02

(57) ABSTRACT

The present disclosure provides a scooter stand configured to receive a foldable scooter in a vertical position with the rear wheel of the scooter placed above its front wheel. The scooter stand comprises a vertical frame, a horizontal frame perpendicularly coupled to the vertical frame, a ramp and a wheel stop. The vertical frame comprises an adjusting mechanism to vary a height of the vertical frame. The ramp is carried by the horizontal frame and the wheel stop is disposed on the horizontal frame and between the ramp and the vertical frame. The ramp, the wheel stop, and the horizontal frame form a receptacle configured to receive a front wheel of a scooter.

### CROSS-REFERENCE TO RELATED APPLICATIONS

The present nonprovisional patent application is a continuation of U.S. patent application Ser. No. 18/627,425, filed on Apr. 4, 2024, which claims the benefit of U.S. provisional patent application Ser. No. 63/457,102, filed on Apr. 4, 2023, and is hereby incorporated by reference in its entirety for all purposes.

### FIELD OF THE DISCLOSURE

The present disclosure relates generally to scooter stands and more specifically to a scooter stand for stand-up foldable electric scooters.

### PRIOR ART

Presently, in urban areas with higher population density, commuting by automobile may be inconvenient and more time-consuming due to heavy traffic and limited parking. As a result, people may preferably opt for other transportation options, including taking public transportation, such as subways and buses, or riding bikes, motorcycles, or scooter that are smaller in size. Among all these options, scooters, especially stand-up electric scooters have become an increasingly popular form of transportation.

Compared to automobile, stand-up electric scooters are easier to maneuver, agile in congested areas, cost-efficient, and environmentally friendly. For convenience and security, users often store electric scooters within their residences or garages. Nevertheless, a standard stand-up electric scooter takes up about 5 square feet of floor space and can easily tip over if bumped into.

Consequently, there is a need for an adjustable scooter stand configured to secure the stand-up electric scooter in a folded vertical position, to reduce a likelihood of tipping over and to reduce required floor space.

### SUMMARY OF THE DISCLOSURE

The following is a concise summary of the disclosure presented herein with the primary aim of providing a preliminary understanding of certain aspects of the disclosure. It should be noted, however, that this summary is not intended to serve as a comprehensive overview of the disclosure or the boundaries of its scope. Its sole purpose is to provide a rudimentary understanding of the disclosure's concept and features, which will be expounded upon in greater detail in the ensuing sections.

A non-limiting exemplary embodiment (the “exemplary embodiment”) of the present disclosure provides a scooter stand and is disclosed herein. The exemplary embodiment of the scooter stand generally comprises a vertical frame, a horizontal frame perpendicular coupled to the vertical frame, a ramp carried by the horizontal frame, and a wheel stop. The vertical frame is adjustable to fit various sizes of scooters. The scooter stand holds a folded scooter in a vertical position where the rear wheel of the scooter is above its front wheel. It is preferable that the scooter stand be constructed of rigid or unbendable materials, such as metal or hard plastic.

The vertical frame comprises an adjusting mechanism to vary a height of the vertical frame in a vertical direction and may further comprise two outer vertical bars and two inner vertical bars. The two outer vertical bars are parallelly separated by a predetermined distance and each of the two inner vertical bars are movably disposed within each of the outer vertical bars respectively. A first locking mechanism is positioned at an overlapping portion of the outer vertical bar and the inner vertical bar for locking the vertical frame to a locking position at a desired height.

The horizontal frame has a front end and a rear end. Preferably, the horizontal frame further comprises a front horizontal frame and a rear horizontal frame. The vertical frame is coupled to the front horizontal frame. To provide additional support to the scooter stand, the scooter stand may further comprise at least one support, a front bar, an intermediate bar, and a rear bar. The at least one support couples to the vertical frame on one end and couples to the horizontal frame on another end. The front bar, the intermediate bar, and the rear bar are coplanar and perpendicular to the horizontal frame. The front bar is disposed at the front end of the horizontal frame, the rear bar is disposed at the rear end of the horizontal frame, and the intermediate bar is disposed between the front bar and the rear bar.

The ramp is carried by the horizontal frame at the rear end, and the wheel stop is disposed on the horizontal frame and between the vertical frame and the ramp. The ramp, the wheel stop and the horizontal frame form a receptacle for receiving a front wheel of the scooter. The ramp may be mounted to a bottom plate which may, in turn be coupled to the horizontal frame.

In another aspect, the horizontal frame may be adjustable, such that a length of the horizontal frame may vary to fit various scooters. Furthermore, at least one of the ramp or the wheel stop may also be adjustable to vary a distance between the ramp and the wheel stop, such that the receptacle may be adjusted to accommodate front wheels with various diameters.

In addition, the scooter stand may further comprise a yoke, a concaved linking bar and a strap. The yoke and the concaved linking bar have a substantially U-shaped profile with an opening facing the rear end of the horizontal frame. The yoke is disposed on a top end of the vertical frame, and the concaved linking bar is disposed between the yoke and the at least one support and connecting the spaced apart outer vertical bars.

It is anticipated that the vertical and horizontal frames may vary in form. For example, the vertical frame may instead comprise two spaced apart telescopic vertical tubes, each of which further comprises an outer vertical tube and a movable inner vertical tube partially disposed within the outer vertical tube. Similarly, the horizontal frame may instead comprise two telescopic horizontal tubes separated by a predetermined distance, each including an outer horizontal tube and a movable inner horizontal tube partially disposed within the outer horizontal tube. A bottom end of each of the horizontal tubes is perpendicularly connected to a front portion of each of the respective horizontal tubes.

Advantageously, the exemplary embodiment of the scooter stand not only adjusts to fit various sizes of scooters, but also reduces the required floor space to less than about 2 square feet and prevents the scooters from tipping over.

The above features and advantages will become apparent from the following detailed description taken with the accompanying drawings.

### BRIEF DESCRIPTION OF DRAWINGS

FIG. 1 is a front perspective view of an exemplary embodiment of a scooter stand.

FIG. 2 is a partially explosive view of the exemplary embodiment of the scooter stand.

FIG. 3 is a first explosive view showing parts of the exemplary embodiment of the scooter stand.

FIG. 4 is a second explosive view showing parts of the exemplary embodiment of the scooter stand.

FIG. 5 is an in-use perspective view showing the scooter and helmet held by the scooter stand.

FIG. 6 is a perspective view showing the scooter stand with a charger holder.

FIG. 7 is an in-use perspective view showing the scooter held by the scooter stand with the charging holder.

### NUMBERING REFERENCE

10—Scooter Stand
100—Vertical Frame
102—Inner Vertical Bar
102a—Top End
102b—Bottom End
104—Outer Vertical Bar
104a—Top End
104b—Bottom End
106—Support
110—First Aperture
112—Adjusting mechanism/First Locking Mechanism
120—Yoke
122—Arm
124—Connecting Member
130—Strap
132—Side Release Buckle
140—Linking Bar
200—Horizontal Frame
200a—Front End
200b—Rear End
202—Front Horizontal Frame
202a—Front End
202b—Rear End
204—Rear Horizontal Frame
204a—Front End
204b—Rear End
204c—Side
206—Bottom Plate
206a—Base
206b—Extensions
210—Second Aperture
212—Second Locking Mechanism
220—Front Bar
222—Intermediate Bar
224—Rear Bar
230—Ramp
230a—Groove
232—Ramp Frame
232a—Ridge Portion
232b—Oblique Surface
234—Wheel Stop
236—Receptacle
240—Helmet Hanger
242—Podium
244—Linking Member
250—Non-skid Pads
300—Scooter
302—Scooter Stem
304—Horizontal Deck
306—Front Wheel
308—Rear Wheel
310—Helmet
312—Charger Holder

### DETAILED DESCRIPTION OF THE DISCLOSURE

The following detailed description and accompanying drawings provide a comprehensive disclosure of an exemplary embodiment for the purpose of facilitating one of ordinary skill in the relevant art to make and use the disclosure. As such, the detailed description and illustration of the one or more exemplary embodiments presented herein are purely exemplary in nature and are not intended to limit the scope of the disclosure or its protection in any matter. It is further noted that the drawings may not be to scale, and in some cases, certain details may be omitted which are not necessary for an understanding of the present disclosure, such as conventional details of fabrication and assembly. Furthermore, there is no intention to be bound by any expressed or implied theory presented in the preceding technical field, background, brief summary or the following detailed description.

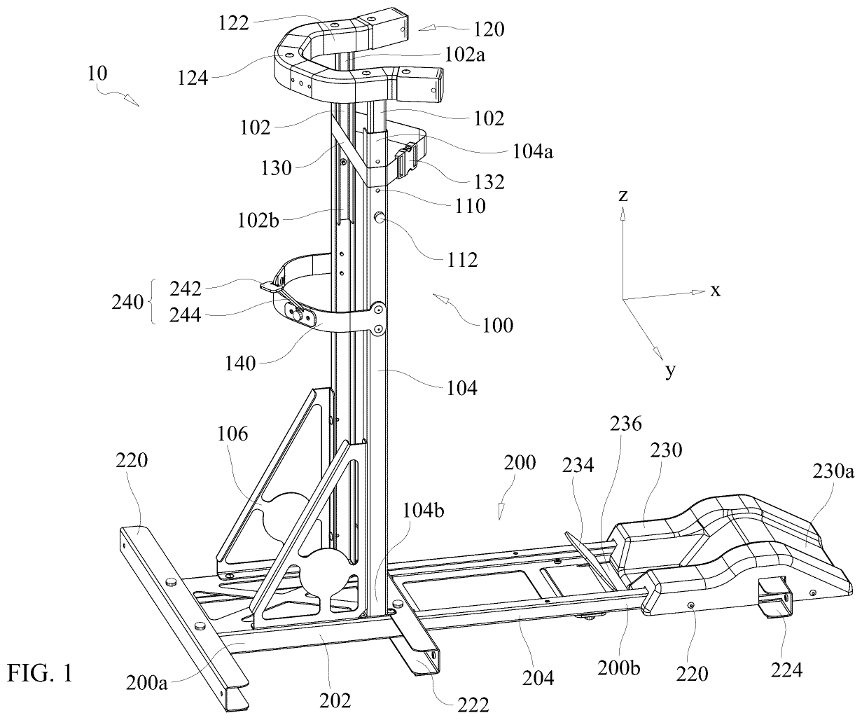

For purposes of description herein, various spatial terms, such as “top”, “bottom”, “front”, “rear”, “horizontal”, “vertical” and derivatives thereof may be used to describe relative positions of one element and another element with respect to the drawings and shall relate to the device as oriented in FIG. 1. However, it should be understood that these terms are not intended to be limiting or absolute.

A non-limiting, exemplary embodiment (hereinafter as “the exemplary embodiment”) of a scooter stand 10 is disclosed herein. The scooter stand 10 provides support to a foldable scooter by holding a folded scooter in a vertical position, thereby minimizing storage space. Moreover, the scooter stand 10 is also adjustable to accommodate various scooters which may vary in size and in diameter of the front wheel.

Referring initially to FIG. 1, a scooter stand 10 is illustrated in accordance with the exemplary embodiment. The scooter stand 10 generally comprises an adjustable vertical frame 100, a horizontal frame 200, a ramp 230, and a wheel stop 234. The vertical frame 100 may extend in a vertical direction z that is perpendicular to a longitudinal direction y and a transverse direction x. The horizontal frame 200 may extend in the transverse direction x. Preferably, the vertical frame 100 is coupled to a front portion of the horizontal frame 200. The vertical frame 100 further comprises two outer vertical bars 104 that are parallel to each other, and separated by a predetermined distance, and two inner vertical bars 102. Each of the outer vertical bars 104 and the inner vertical bars 102 has a top end 102a, 104a and a bottom end 102b, 104b. Each of the inner vertical bars 102 has a smaller width than each of the vertical frame 100 and is partially disposed and movable within the outer vertical bars 104 in the vertical direction z. A first locking mechanism 112, (which can be any suitable locking mechanism, such as nuts, bolts and the like), as shown in FIG. 1, is positioned at an overlapping portion of the outer vertical bar 102 and the inner vertical bar 104 for locking the vertical frame 100 to a locking position. Each of the inner vertical bars 104 and the outer vertical bars 102 comprises a plurality of apertures 110 aligned in a column along the vertical direction z configured to receive the first locking mechanism 112. As a result, the inner vertical bars 102 may be adjusted to a desired height having one of the apertures 110 of the inner vertical bar 102 aligned with one of the apertures 110 of the inner vertical bar 104, such that a first component of the first locking mechanism 112 (i.e., a bolt) may be inserted through the aligned apertures 110 and be fastened by a second component of the first locking mechanism 112 (i.e., a nut). The first locking mechanism 112 may alternatively include, but is not limited to screws, latches, button locks, and any suitable adjustable fasteners known in the art. Although the arrangement of the exemplary embodiment shown in FIG. 1 preferably shows the inner vertical bar 102 being movable along the top end 104a of the outer vertical bar 104, this arrangement may be opposite, having the outer vertical bar 104 being movable along the top end 102a of the inner vertical bar 102.

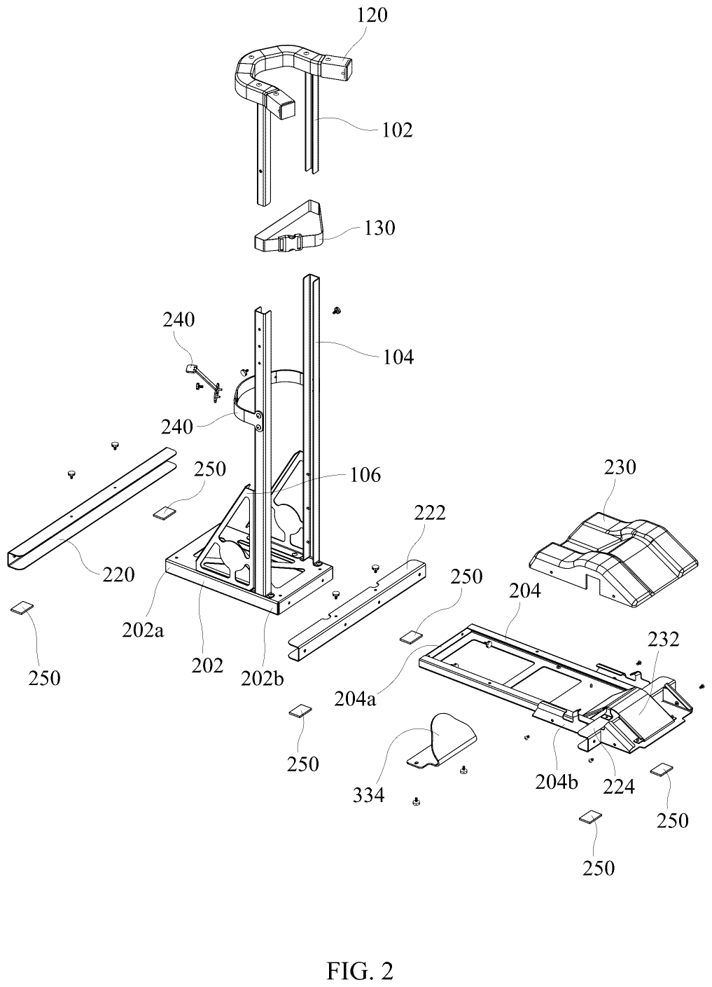

With continuing reference to FIG. 1 and in conjunction with FIG. 2, the horizontal frame 200 has a front end 220a and a rear end 220b and further comprises a front horizontal frame 202, a rear horizontal frame 204, and a bottom plate 206. To increase steadiness and securement, the exemplary embodiment further comprises at least one support 106, a front bar 220 and an intermediate bar 222, thereby mitigating the risk of the scooter stand 10 tilting or tipping over. It is preferable that the at least one support 106 has a substantial triangular configuration having a right angle positioned at an intersection (or a joining portion) of the vertical frame 100 and the horizontal frame 200 (i.e., where the vertical frame 100 intersects with the horizontal frame 200), with the at least one support 106 having a first side coupling to the vertical frame 100, and a second side adjacent to the first side coupling the horizontal frame 200. The front bar 220 and the intermediate bar 222 extend in the longitudinal direction y and are coplanar to the horizontal frame 200. The front bar 220 is coupled to a front end 202a of the front horizontal frame 202, and the intermediate bar 222 is coupled to a rear end 202a of the front horizontal frame 202 and a front end 204a of the rear horizontal frame 204. The ramp 230 is mounted on the bottom plate 206 which is, in turn, coupled to the rear end of the rear horizontal frame 204. The wheel stop 234 is disposed on the horizontal frame 200 and in between the intermediate bar 222 and the ramp 230. The wheel stop 234, the ramp 230 and the horizontal frame 200 form a receptacle configured to receive a front wheel of the scooter. Although the bottom plate 206 is fixed to the rear horizontal frame 204 in the exemplary embodiment, it is anticipated that the bottom plate 206 may be slidably movable along the front horizontal frame 202 in the transverse direction x.

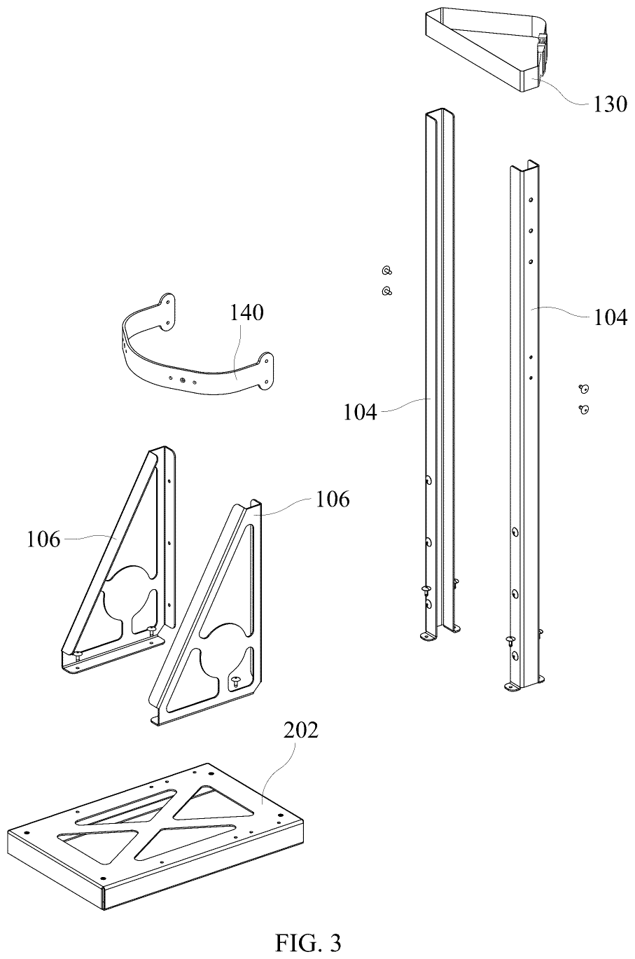

With continuing reference to FIGS. 1 and 2, FIG. 3 shows an exploded view of some of the components of the scooter stand 10. As shown in FIG. 3, a strap 130 is connected to a top portion of each of the outer vertical bars 104. The strap 130 may be used to tie a stem of the scooter to the vertical frame 100. A concaved linking bar 140 is attached to a middle portion of each of the outer vertical bars 104. The linking bar 140 connects the two outer vertical bars 104 forming a space to accommodate a scooter bag (not shown) that may be attached to the scooter. The at least one support 106 is connected to bottom portion of each of the two outer vertical bars 104. The at least one support 106 can include two supports 106, although any suitable number of supports 106 can be used. The at least one support 106 can have a triangular shape, although any suitable shape can be used. The support(s) 106 provide stability for the vertical frame 100 when attached to the horizontal frame 200. The front horizontal frame 202 is attached to a bottom surface of each of the two outer vertical bars 104. A bottom surface of each support 106 is attached to a top surface of the front horizontal frame 202.

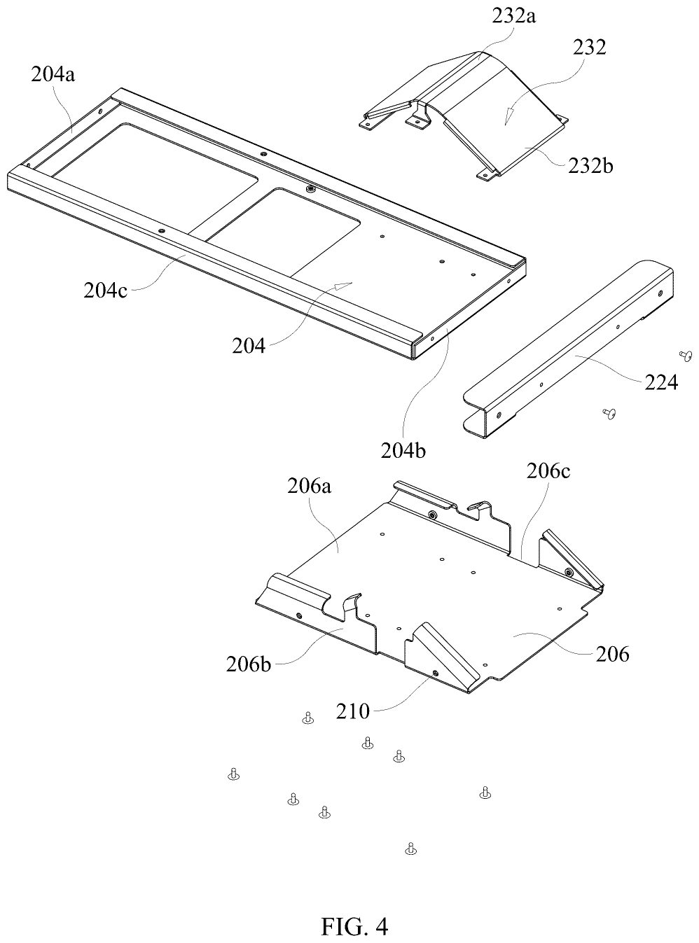

Turning to FIG. 4 and in conjunction with FIG. 2, the bottom plate 206 further comprises a base 206a and extensions 206b extending upwards from both sides of the base 206. Each of the extensions 206b further includes a notch 206c. The two notches 206c are configured to receive a rear bar 224 which extends along the longitudinal direction y. The rear bar 224 has a length greater than a width of the horizontal frame 200. In addition, the ramp 230 comprises a ramp frame 232 having a substantial slope configuration is disposed on the bottom plate 206 and below the ramp frame 232 to provide additional support to the ramp frame 232. The ramp frame 232 further has a ridge portion 232a extending along the longitudinal direction y and coupled to the rear bar 224, and two oblique surface 232b sloping down from two sides of the ridge portion 232a and coupled to the base 206a of the bottom plate 206. The ramp frame 232 also has a substantial slope configuration similar to the ramp frame 232. The ramp frame 232 further comprises a groove 232a elongating along the transverse direction x to guide the movement of the scooter. It is preferable that the ramp frame 232 be constructed of flexible materials providing a non-slip surface to the front wheel of the scooter. It is anticipated that the shape of the ramp frame 232 and the wheel stop 234 could vary. As shown in FIGS. 1 and 2, the ramp frame 232 includes a first sloped surface and a second sloped surface. The first sloped surface inclines toward a rear end of the horizontal frame 100 and the second sloped surface inclines toward a front end of the horizontal frame 100 and comprises an indentation. The indentation formed by the first and second sloped surfaces of the ramp frame 232, the wheel stop 234, and the horizontal frame 100 form the receptacle configured to receive a front wheel of the scooter.

Referring again to FIGS. 1 and 2, the scooter stand 10 further comprises a yoke 120 and the concaved linking bar 140. The yoke 120 and the linking bar 140 are positioned on paralleled xy-planes and have substantially U-shaped profiles with opening ends facing towards the rear end 200b of the horizontal frame 200. The yoke 120 is attached to the top ends 102a of the inner vertical tube 102, and the linking bar 140 is disposed on the vertical frame 100 and between the yoke 120 and the at least one support 106. Preferably, the yoke 120 has two arms 122 and a slightly curved connecting member 124 connecting the two arms 122. Each of the inner vertical tubes 102 is coupled to a middle portion of one of the arms 122, respectively. The yoke 120 also has an open end (as a result of its U-shaped profile) facing a rear end of the horizontal frame 100, and is positioned between the front bar 202 and an intersection (or joining portion) of the vertical frame 100 and the horizontal frame 200. Moreover, the linking bar 140 may further include a helmet hanger 240 on which a user can hang a helmet (not shown in FIGS. 1 and 2). The helmet hanger 240 has a podium 242 and a linking member 244 connecting the podium 240 to the linking bar 140.

Additionally, several accessories may be added to the scooter stand 10 to fit a user's need. As shown in FIGS. 1, 2, and 5, the strap 130 connects to each of the outer vertical tubes 104 and extends rearwardly therefrom, as well as includes a releasably securing means, such as a side release buckle or hook-and-loop surfaces. To provide frictional resistance and to protect floors from scratching, a plurality of non-skid pads 250 may be added beneath surfaces of the horizontal frame 200, as can be seen in FIG. 2. It is also anticipated that that a foam rest (not shown) may be added to the yoke to act as a buffer to reduce impact and thereby protecting the scooter. It is anticipated that a plurality of scooter stands 10 can be linked together at the front bar 202 by an optional connector. The scooter stand 10 may further include a scooter cover (not shown) for the scooter (not shown), a drip tray (not shown) under the horizontal frame 200, and a cleaning kit.

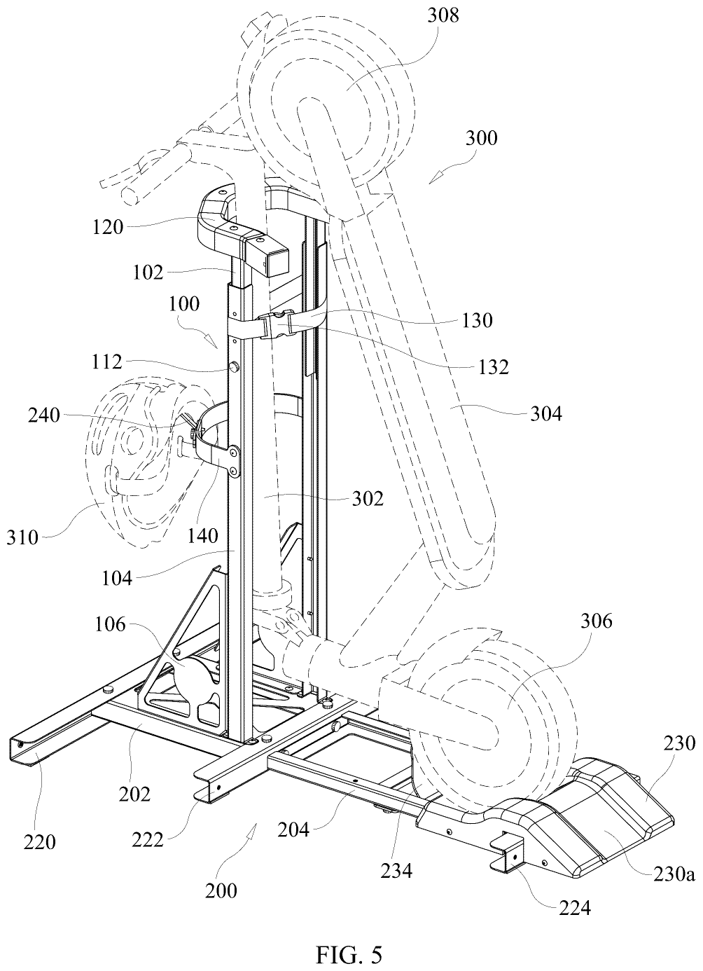

Referring to FIG. 5, an exemplary method of using the scooter stand 10 is presented herein to further demonstrate the convenience of storing a compacted scooter 300 and the customization of the scooter stand 10. It is anticipated that several steps may be sequentially interchangeable and equivalent application of one or more permutations of such sequentially interchangeable steps does not alter the spirit of the disclosure in any meaningful way.

A typical foldable scooter 300 comprises a foldable scooter stem 302 connected to a horizontal deck 304. A front wheel 306 and a rear wheel 308 are rotatably coupled to two ends of the horizontal deck 304.

The scooter stand 10 provides a vertical adjustment to accommodate scooters 300 of various heights. To find the perfect fit for the scooter 300, an exemplary user first guides the scooter 300 towards the scooter stand 10, such that the receptacle 236 accommodates the front wheel 306. Next, the exemplary user raises or lowers the vertical frame 100 in the vertical direction z to a desired height and fix the vertical frame 100 at the desired height by the first locking mechanism 112. The exemplary user can repeat the steps to find the best fit for their scooter 300, thereby stabilizing the scooter 300 using minimal floor space. Upon completion of adjusting the scooter stand 10, the scooter stand 10 is prepared for further storage of the scooter 300.

To store the scooter 300, the exemplary user may first take off a helmet 302 and place the helmet 302 on the helmet hanger 140. Next, the exemplary user may direct the scooter 300 to move in the transverse direction x and roll the front wheel 306 of the scooter 300 along the groove 230a of the ramp 230 until the front wheel of the scooter 300 is placed within the receptacle 236. Afterwards, the exemplary user folds the scooter stem 302 down close to being aligned parallelly to the horizontal deck 304 of the scooter 300 and locks the scooter stem 302 down in place. Then, the exemplary user lifts the rear end of the scooter 300 into the scooter stand 10, such that the scooter 300 is in a vertical position and held by gravity. Lastly, the exemplary user may tighten the strap 132 around the stem of the scooter to secure the scooter 300 to the scooter stand 10.

To remove the scooter 300 from the scooter stand 10, the exemplary user reverses the above steps. First, the exemplary user unbuckles the strap 130. Next, the exemplary user lowers the rear end of the scooter 100 towards the ground, such that the horizontal deck 304 is parallel to the horizontal frame 200. Then the exemplary user unfolds the scooter stem 302 and rolls the front wheel 306 out of the receptacle 236.

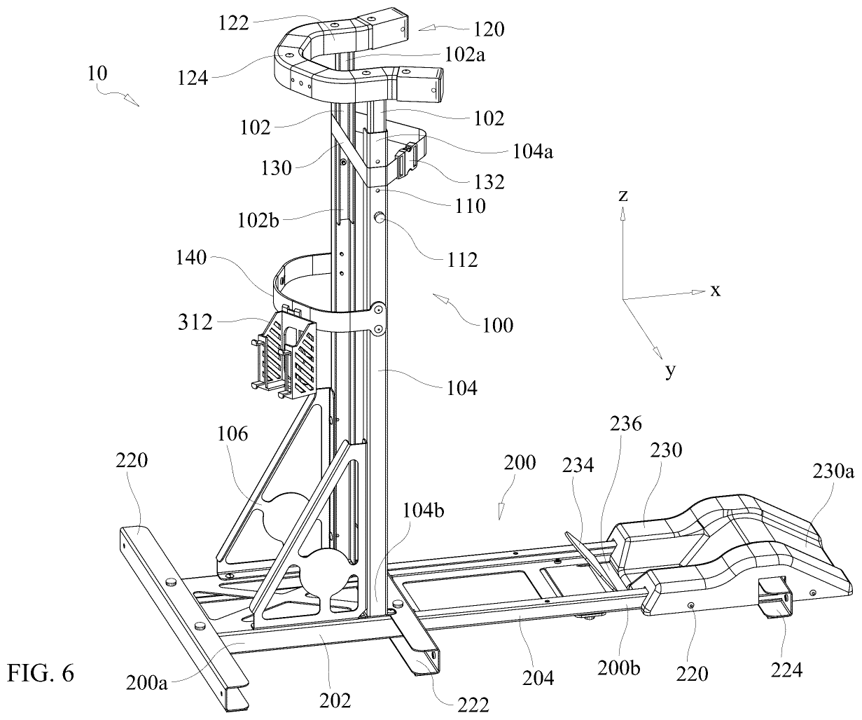

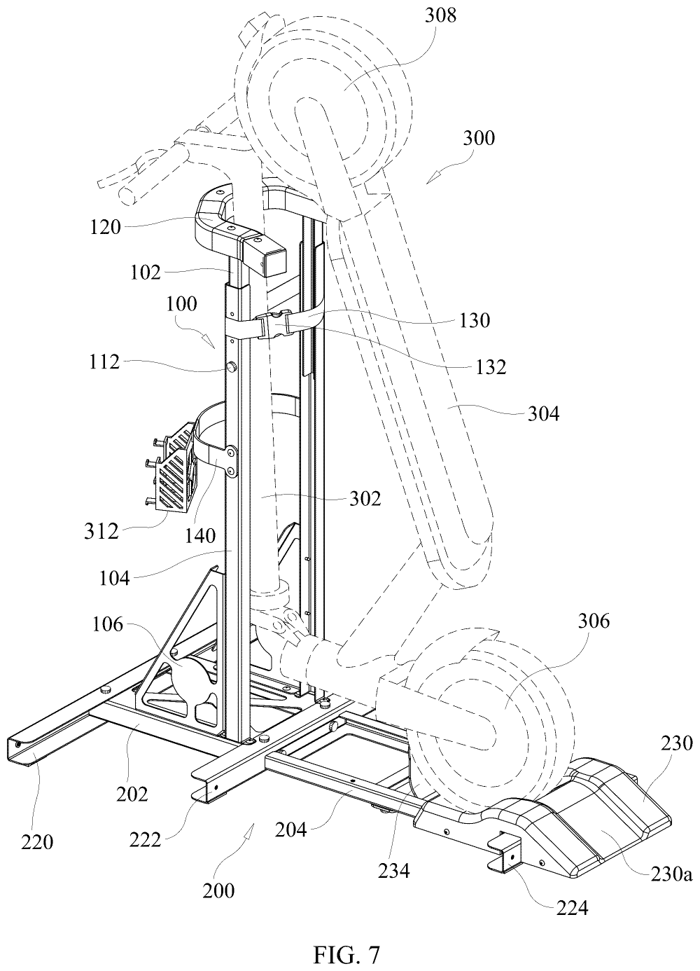

In addition, as shown in FIGS. 6 and 7, the scooter stand 10 may also comprise a charger holder 312 with a wire organizer (not shown) attached to a portion of the vertical frame 100. The charger holder 312 with the wire organizer is configured to receive a charger for the scooter stand 10, and tidy up connected wires or cables. The wire organizer may include but is not limited to a tab, a hook, a clip, a tie, a strap and/or other attachments to secure the wires.

While the embodiments of the disclosure have been disclosed, certain modifications may be made by those skilled in the art to modify the disclosure without departing from the spirit of the disclosure.

1. A scooter stand comprising:
a vertical frame;
a horizontal frame perpendicularly coupled to a bottom end of the vertical frame and comprising a front bar coupled to a front end of the horizontal frame;
a ramp carried by the horizontal frame;
a wheel stop disposed between the ramp and the vertical frame;
wherein the ramp, the wheel stop, and the horizontal frame form a receptacle; and
a yoke having an open end facing a rear end of the horizontal frame, the yoke being coupled to a top end of the vertical frame and positioned between the front bar and an intersection of the vertical frame and the horizontal frame.

2. The scooter stand of claim 1, wherein the vertical frame comprises an adjustment mechanism to vary a height of the vertical frame.

3. The scooter stand of claim 1, wherein the vertical frame further comprises two outer vertical bars and two inner vertical bars; and wherein each of the inner vertical bars is movably disposed within the outer vertical bars.

4. The scooter stand of claim 3, wherein the scooter stand further comprises a first locking mechanism positioned at an overlapping portion of each of the outer vertical bars and each of the inner vertical bars and is configured to lock the vertical frame at a desired height.

5. The scooter stand of claim 1, wherein the scooter stand further comprises a linking bar coupled to the vertical frame.

6. The scooter stand of claim 1, wherein the scooter stand further comprises at least one support, wherein the at least one support couples to the vertical frame on one end and couples to the horizontal frame on another end.

7. The scooter stand of claim 1, wherein the scooter stand further comprises a strap positioned on the vertical frame.

8. The scooter stand of claim 1, wherein the scooter stand further comprises a helmet hanger disposed on the vertical frame.

9. The scooter stand of claim 1, wherein the ramp has a first sloped surface and a second sloped surface.

10. The scooter stand of claim 9, wherein the first sloped surface inclines toward a rear end of the horizontal frame and the second sloped surface inclines toward a front end of the horizontal frame and comprises an indentation.

11. A scooter stand comprising:
a vertical frame;
a horizontal frame perpendicularly coupled to a bottom end of the vertical frame;
a ramp carried by the horizontal frame and having a first sloped surface and a second sloped surface;
wherein the first sloped surface inclines toward a rear end of the horizontal frame and the second sloped surface inclines toward a front end of the horizontal frame and comprises an indentation;
a wheel stop disposed between the ramp and the vertical frame;
wherein the indentation, the wheel stop, and the horizontal frame form a receptacle; and
a yoke having an opening end facing the rear end of the horizontal frame and coupled to a top end of the vertical frame.

12. The scooter stand of claim 11, wherein the vertical frame comprises an adjustment mechanism to vary a height of the vertical frame.

13. The scooter stand of claim 11, wherein the vertical frame further comprises two outer vertical bars and two inner vertical bars; and wherein each of the inner vertical bars is movably disposed within the outer vertical bars.

14. The scooter stand of claim 13, wherein the adjusting mechanism is positioned at an overlapping portion of the outer vertical bars and the inner vertical bars and comprises a first locking mechanism configured to lock the vertical frame at a desired height.

15. The scooter stand of claim 14, wherein the first locking mechanism comprises a set of bolt and nut.

16. The scooter stand of claim 11, wherein the scooter stand further comprises a linking bar coupled to the vertical frame.

17. The scooter stand of claim 11, wherein the scooter stand further comprises at least one support, wherein the at least one support couples to the vertical frame on one end and couples to the horizontal frame on another end.

18. The scooter stand of claim 11, wherein the scooter stand further comprises a strap positioned on the vertical frame.

19. The scooter stand of claim 11, wherein the scooter stand further comprises an helmet hanger disposed on the vertical frame.

20. The scooter stand of claim 11, wherein the yoke has a substantially U-shaped profile.
